(19) United States
(12) Patent Application Publication
(10) Pub. No.: US 2026/0253296 A1
(43) Pub. Date: Aug. 27, 2026

(54) GRAPHICALLY REPRESENTING AN AI AGENT PARTICIPANT IN A COLLABORATION SESSION

(71) Applicant: MICROSOFT TECHNOLOGY LICENSING, LLC, Redmond, WA (US)

(72) Inventors: Daniel ROSENSTEIN, Issaquah, WA (US); Richard Jason ORTEGA, New York City, NY (US)

(21) Appl. No.: 19/059,918

(22) Filed: Feb. 21, 2025

(51) Int. Cl. G06T 13/40; G06T 13/80; H04L 65/1093; H04L 65/403

(52) U.S. Cl. CPC G06T 13/40; G06T 13/80; H04L 65/1093; H04L 65/403; G06T 2200/24

(57) ABSTRACT

A system implements techniques for executing a collaboration session between at least one human participant, at least one robotic device participant, and at least one artificial intelligence agent participant. The collaboration session can be executed in relation to a mission to be completed within a geographical environment. The system graphically represents artificial intelligence agent participants, in the context of the collaboration session, based on different types (e.g., a general-purpose artificial intelligence agent participant, a specific-purpose artificial intelligence agent participant). The graphical representations of artificial intelligence agent participants ensures smooth collaboration and provides an element of a visual feedback, to human participants, as to which artificial intelligence agent participants are actively engaged and/or what the actively engaged artificial intelligence agent participants are currently doing to in the context of the collaboration session.

### BACKGROUND

The use of robotic devices is becoming more prevalent in the world. For instance, different types of robotic devices have recently been configured to perform various tasks for humans. In some cases, the performance of tasks by robotic devices replaces the need for humans to perform the tasks (e.g., dangerous tasks, time-consuming tasks). Thus, in many areas of life, robotic devices have been proven to improve the way in which people live.

The tasks that can be performed by robotic devices are becoming more complex. Furthermore, the tasks that can be performed by robotic devices are becoming interrelated. Unfortunately, existing systems fail to provide a way for effective and efficient coordination of robotic devices that are expected to perform complex and interrelated tasks. It is with respect to these and other considerations that the disclosure made herein is presented.

### SUMMARY

The system described herein implements techniques for executing a collaboration session between at least one human participant, at least one robotic device participant, and at least one artificial intelligence agent participant. More specifically, the system described herein graphically represents artificial intelligence agent participants, in the context of the collaboration session, based on different types (e.g., a general-purpose artificial intelligence agent participant, a specific-purpose artificial intelligence agent participant). The graphical representations of artificial intelligence agent participants ensures smooth collaboration and provides an element of a visual feedback, to human participants, as to which artificial intelligence agent participants are actively engaged and/or what the actively engaged artificial intelligence agent participants are currently doing to in the context of the collaboration session.

As described herein, a robotic device is a programmable device configured to implement a series of physical actions automatically. In this context, “automatically” means the physical actions are implemented via the embedded programming of the robotic device and/or via remote control of the robotic device (e.g., in a scenario where a human and robotic device are not co-located).

In various examples described herein, the collaboration session is executed in relation to a mission to be completed within a geographical environment. A mission defines one or more goals. Accordingly, a mission typically includes a set of tasks to be completed to achieve the goals. In various examples, the mission is related to a response to an event and the set of tasks to be completed in accordance with the mission is distributed across available resources. More specifically, different human and/or robotic device roles may have varied responsibilities in implementing different tasks to complete the mission.

As an illustrative example, an event may be a natural disaster such as a fire from a lightning strike, a hurricane, or an earthquake. The use of robotic devices can be helpful in responding to a natural disaster event. Typically, multiple organizations respond to execute and/or complete a mission with the goal of helping people that are affected by the natural disaster event. For instance, first tasks for the mission may be related to finding and rescuing survivors (e.g., removing people from dangerous areas). Second tasks for the mission may be related to limiting further damage caused by the natural disaster event (e.g., finding areas where the fire is burning and extinguishing the fire, securing unstable buildings). Third tasks for the mission may be related to identifying damaged/offline “utility” infrastructure (e.g., electric grid infrastructure, water supply infrastructure, gas pipeline infrastructure) and fixing the damage/offline utility infrastructure so it comes back online in due time.

In the illustrative example of the preceding paragraph, the multiple organizations often include different government agencies from local, state, and/or federal jurisdictions. Moreover, the multiple organizations may include private and/or charitable organizations as well. Each of the organizations may include their own personnel, their own experiences and/or procedures with respect to deploying robotic devices, as well as their own execution and/or communications infrastructure to operate the robotic devices. When different personnel and different types of robotic devices from different organizations converge on a geographical environment in response to an event such as a natural disaster, it is difficult to coordinate the tasks so that the mission can be achieved in a more effective and efficient manner.

The collaboration session described herein creates an effective and efficient solution for humans and robotic devices to coordinate the performance of the mission. Additionally, the collaboration session described herein allows for artificial intelligence agents to assist in the coordination of the performance of the mission. For instance, via the execution of a collaboration session, humans from different organizations that use heterogenous robotic devices (e.g., different types of robotic devices, different types of communications) can quickly connect through a central system to collaborate and coordinate performance of tasks that are intended to complete a mission. Moreover, access to an intelligence layer provided by artificial intelligence agents that are able to participate in the collaboration session enhances the collaboration and coordination.

The illustrative example of a natural disaster event provided above is a larger-scale event. However, it is understood in the context of this disclosure that a mission can be implemented at different scales. For instance, a mission can also be implemented in response to a smaller-scale event that only requires coordination and collaboration between a limited number of humans (e.g., one, two, or three humans), a limited number of robotic devices (e.g., one, two, or three robotic devices), and a limited number of artificial intelligence agents (e.g., one, two, or three artificial intelligence agents). For example, a collaboration session may be created for a human to coordinate with a robotic device and/or an artificial intelligence agent to find a particular team member (e.g., determine a current location of the particular team member) in an office building so the team member can resolve a project issue a team has encountered. In this example, the event is the project issue and the mission is finding the particular team member. In another example discussed herein, a collaboration session may be created for humans to coordinate with robotic devices and/or artificial intelligence agents to execute tasks at a construction site.

As shown via the examples described above, the coordination enabled via the collaboration session described herein may be scaled to apply in any context in which work (e.g., a mission) needs to be done by a human, a robotic device, and an artificial intelligence agent. Various example contexts include disaster response, safety and security, healthcare and medical instrumentation, manufacturing and industrial lines/warehouses, office and/or personal management, agriculture, construction, and so forth. Accordingly, a geographical environment, as described herein, can include an identifiable “real-world” setting and/or area. The identifiable real-world setting and/or area can be indoor, such as an office building, a retail building, a personal residence, a warehouse, a hospital, a medical office, a factory floor, a manufacturing line, or other types of settings and/or areas within physical structures that can be blueprint- or human-defined. Alternatively, the identifiable real-world setting and/or area can be outdoor, such as a forest, a mountain, a construction site, a neighborhood, a town, a city, a county, a state, a country, a field, a pasture, or other type of outdoor settings and/or areas that can be map- or human-defined.

Robotic devices can operate on land, on water, in the air, in space, or a combination thereof, and can be programmed to perform different tasks. For example, an unmanned aerial vehicle (UAV) may be tasked with capturing video and/or dropping items from the sky. A sea drone may be tasked with capturing video and/or providing supplies to an area that cannot be reached by land. A bomb disposal robotic device may be tasked with capturing video and/or safely disabling an explosive device. A backhoe robotic device may be tasked with capturing video and/or moving dirt, rocks, and/or rubble. A dump truck robotic device may be tasked with capturing video and hauling away dirt, rocks, and/or rubble. An office or retail robotic device may be tasked with stocking retail and/or supply shelves. A warehouse robotic device may be tasked with sorting items in bins. A manufacturing robotic device may be tasked with connecting two parts of an apparatus. These example robotic devices are just a few of the numerous different types of robotic devices that have been manufactured and configured to perform various tasks in varying contexts.

Regardless of the size and/or scope of the mission and/or a scale of an event to which the mission responds, the collaboration session described herein enables at least one human and one robotic device to work together in conjunction with an artificial intelligence agent. The artificial intelligence agent functions as a translation and/or orchestration interface between the human and the robotic device. The collaboration session presents a low barrier of entry for humans and/or robotic devices to be part of a coordinated mission. Moreover, the collaboration session enables the integration of heterogenous robotic devices (e.g., different fleets of robotic devices) that are not designed and/or configured to communicate with one another. Moreover, through the use of the aforementioned accessible artificial intelligence agent, the collaboration session enables effective participation for humans without detailed working knowledge of the robotic devices deployed to the geographical environment in which the mission is being implemented, thereby reducing the cognitive load required for successful missions and increasing the overall efficiency for mission completion.

The humans, robotic devices, and/or artificial intelligence agents participating in a collaboration session are respectively referred to herein as human participants, robotic device participants, and artificial intelligence agent participants. The disclosed system is configured to expose an application programming interface that allows robotic devices to access and download a “robot agent” that enables robotic device participation in the collaboration session. The robot agent includes centralized code that configures the robotic devices with communication and/or configuration software that is compatible with the collaboration session. That is, after downloading the robot agent, a robotic device can participate in the collaboration session via the communication (e.g., transmission) of robot data.

In one example, the robot data includes sensor data sensed by a sensor embedded in a robotic device participant. More specifically, the sensor data can include one or more of image data (e.g., still images) captured by an image capture device embedded in or attached to the robotic device participant, video data (e.g., a sequence of video frames) captured by a video capture device embedded in or attached to the robotic device participant, audio data captured by a microphone embedded in or attached to the robotic device participant, temperature data captured by a thermometer embedded in or attached to the robotic device participant, air quality data captured by an air quality sensor embedded in or attached to the robotic device participant, pressure data captured by a pressure sensor embedded in or attached to the robotic device participant, velocity data captured by a velocity sensor embedded in or attached to the robotic device participant, smoke data captured by a smoke detecting sensor embedded in or attached to the robotic device participant, gas data captured by a gas detecting sensor embedded in or attached to the robotic device participant, thermal data captured by a thermal sensor embedded in or attached to the robotic device participant, depth data captured by a depth sensor embedded in or attached to the robotic device participant, odor (smell) data captured by an odor sensor embedded in or attached to the robotic device participant, lidar data captured by a laser component embedded in or attached to the robotic device participant, radar data captured by a radar component embedded in or attached to the robotic device participant, or infrared (IR) data captured by an IR sensor embedded in or attached to the robotic device participant. While a list of example types of data and/or sensors is provided above, it is understood in the context of this disclosure, that a robotic device participant can be configured with hardware, firmware, and/or software to detect and/or sense any type of environmental data. In another example, the robot data includes location data for the robotic device (e.g., a Global Positioning System (GPS) location).

The robot agent made available by the system via the application programming interface configures a bi-directional communication bridge between a robotic device and the collaboration session. More specifically, this bi-directional communication bridge connects the robotic device to cloud infrastructure that hosts the collaboration session via different types of networks including private and/or public local area networks (LANs), private and/or public metropolitan area networks (MANs), private and/or public wide area networks (WANs), Wi-Fi networks, public and/or private mobile networks (e.g., 5G networks, LTE networks), satellite networks, radio networks, and so forth.

The collaboration session is started when any of the participants (e.g., a human participant, a robotic device participant, or an artificial intelligence agent participant) creates the collaboration session and joins the collaboration session. The participant that starts the collaboration session can then add other participants to the collaboration session via an invitation to join. In various examples, the invitation to join is a notification that wakes a robotic device participant from a sleep state and/or activates the robotic device agent to enable the bi-directional communication bridge to/from the collaboration session. As described above, after a robotic device participant has joined the collaboration session, the robotic device can start communicating (e.g., reporting) sensor data and/or location data to the collaboration session.

After the collaboration session is started, the system generates an interaction environment for the collaboration session. As described in further detail below, the interaction environment includes a graphical representation for each of a plurality of participants that have joined the collaboration session. The system provides the interaction environment to a computing device associated with the human participant, as further discussed below in the examples of the Detailed Description. Moreover, the system provides a context of the whole interaction environment, or a particular aspect of the interaction environment (e.g., a video stream), to an artificial intelligence agent for processing and analysis.

To generate a graphical representation for an artificial intelligence agent participant, the system first determines a type of the artificial intelligence agent participant. The system can determine a type of the artificial intelligence agent participant by mapping an identifier (e.g., a name) of the artificial intelligence agent participant to a defined type or by accessing metadata for the artificial intelligence agent participant which defines a type. A first example type of artificial intelligence agent participant includes a general-purpose type of artificial intelligence agent participant. A general-purpose type of artificial intelligence agent participant is one that provides general intelligence to mission execution (e.g., general construction safety practices for a construction site, general understanding of how fires spread when responding to a forest fire). If the type of artificial intelligence agent participant is determined to be a general-purpose type of artificial intelligence agent participant, then the graphical representation generated for the artificial intelligence agent participant is a human-like graphical representation in an example.

A second example type of artificial intelligence agent participant includes a specific-purpose type of artificial intelligence agent participant. A specific-purpose type of artificial intelligence agent participant is one that is dedicated to providing support for a specific type of robotic device participant, and thus, provides specific intelligence to mission execution. Consequently, a specific-purpose type of artificial intelligence agent participant is configured and trained at a lower level to support tasks capable of being executed by a specific type of robotic device participant, while a general-purpose type of artificial intelligence agent participant is configured and trained at a higher level to support more general goals, strategies, policies, practices related to the mission. If the type of artificial intelligence agent participant is determined to be a specific-purpose type of artificial intelligence agent participant, then the graphical representation generated for the artificial intelligence agent participant is a robot-like graphical representation in an example.

The graphical representation generated for an artificial intelligence agent participant can have different states. A first example state includes an inactive state. The graphical representation generated for an artificial intelligence agent participant is displayed in the inactive state when the artificial intelligence agent participant is present in the collaboration session but has not been called upon to provide information. A second example state includes an active state. The graphical representation generated for the artificial intelligence agent participant is displayed in the active state when the artificial intelligence agent participant is called upon to provide information in the context of the collaboration session.

The inactive state and the active state are graphically distinguished from one another to provide an element of visual feedback to the human participants as to which artificial intelligence agent participants are actively engaged. For example, the active state provides a larger and/or more detailed view of the human-like and/or robot-like graphical representations. In another example, the active state provides animated elements to help personify the human-like and/or robot-like graphical representations (e.g., move lips to reflect speech, move arms and/or shoulders to perform a gesture, change facial expressions for emphasis). In a more specific example, the active state of a specific-purpose type of artificial intelligence agent participant can audibly explain tasks that the robotic device participant is implementing in the geographical environment.

Accordingly, the system can determine that an artificial intelligence agent participant, for which the graphical representation is currently displayed in the inactive state, has been called upon to provide information in the context of the collaboration session. Based on this determination, the system transitions the graphical representation for the artificial intelligence agent participant from the inactive state to the active state. In various examples, the system can determine that a period of inactivity, associated with the artificial intelligence agent participant while the graphical representation is currently displayed in the active state, has expired in the context of the collaboration session. Based on this determination, the system transitions the graphical representation for the artificial intelligence agent participant from the active state back to the inactive state.

This Summary is provided to introduce a selection of concepts in a simplified form that are further described blow in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 illustrates an example environment in which a system executes a collaboration session between at least one human participant, at least one robotic device participant, and at least one artificial intelligence agent participant, and further, in which the system graphically represents the at least one artificial intelligence agent participant based on different types.

FIG. 2 illustrates further aspects of the system executing a collaboration session that graphically represents artificial intelligence agent participants based on different types.

FIG. 3 illustrates state transitions that occur with respect to a graphical representation of an artificial intelligence agent participant in a collaboration session.

FIG. 4A illustrates an example interaction environment where graphical representations for artificial intelligence agent participants based on type are displayed.

FIG. 4B illustrates the example interaction environment of FIG. 4A, where the graphical representations of the artificial intelligence agent participants have transitioned from inactive states to active states.

FIG. 5A illustrates an example interaction environment where an artificial intelligence agent participant is called upon by a human participant to use its intelligence and to provide information.

FIG. 5B illustrates the example interaction environment of FIG. 5A, where a graphical representation of the artificial intelligence agent participant has transitioned from an inactive state to an active state in response to being called upon by the human participant to use its intelligence and to provide information.

FIG. 5C illustrates the example interaction environment of FIG. 5B, where a graphical representation of the artificial intelligence agent participant has transitioned from an inactive state to an active state in response to being called upon by the other artificial intelligence agent participant to use its intelligence and to provide information.

FIG. 5D illustrates an example interaction environment of FIG. 5C, where an artificial intelligence agent participant is able to output (e.g., as an overlay) graphical elements based on its analysis.

FIG. 5E illustrates the example interaction environment of FIG. 5C, where an artificial intelligence agent participant and a robotic device participant are combined into a single display area of the interaction environment, which display graphical elements from both participants (e.g., a video stream from the robotic device participant and artificial intelligence overlays based on artificial intelligence analysis).

FIG. 6 illustrates a process for executing a collaboration session between at least one human participant, at least one robotic device participant, and at least one artificial intelligence agent participant, where the system graphically represents the at least one artificial intelligence agent participant based on different types.

FIG. 7 is a computer architecture diagram illustrating an illustrative computer hardware and software architecture for a computing system capable of implementing aspects of the techniques and technologies presented herein.

### DETAILED DESCRIPTION

The system described herein implements techniques for executing a collaboration session between at least one human participant, at least one robotic device participant, and at least one artificial intelligence agent participant. In various examples described herein, the collaboration session is executed in relation to a mission to be completed within a geographical environment. A mission defines one or more goals. Accordingly, a mission typically includes a set of tasks to be completed to achieve the goals. In various examples, the mission is related to a response to an event and the set of tasks to be completed in accordance with the mission is distributed across available resources. More specifically, different human and/or robotic device roles may have varied responsibilities in implementing different tasks to complete the mission.

The system described herein graphically represents artificial intelligence agent participants, in the context of the collaboration session, based on different types (e.g., a general-purpose artificial intelligence agent participant, a specific-purpose artificial intelligence agent participant). The graphical representations of artificial intelligence agent participants ensures smooth collaboration and provides an element of a visual feedback, to human participants, as to which artificial intelligence agent participants are actively engaged and/or what the actively engaged artificial intelligence agent participants are currently doing to in the context of the collaboration session.

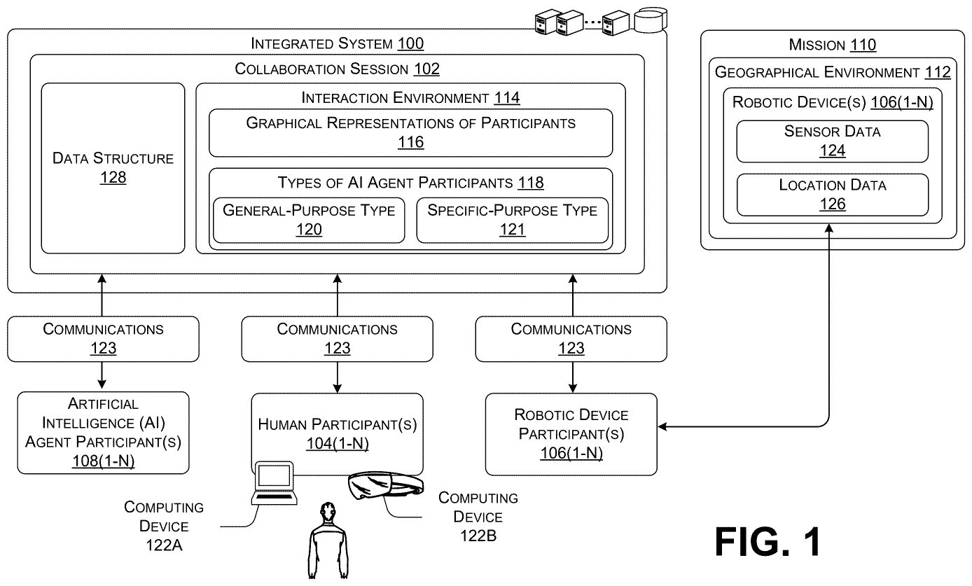

FIG. 1 illustrates an example environment in which a system 100 creates and/or executes a collaboration session 102 between one or more human participant(s) 104(1-N), one or more robotic device participant(s) 106(1-N), and one or more artificial intelligence (AI) agent participant(s) 108(1-N). The number N represents a positive integer number and can be the same or different for the human participants 104(1-N), the robotic device participants 106(1-N), and the AI agent participants 108(1-N). For example, the numbers for the different types of participants can be smaller (e.g., one, two, three, four) if the collaboration session 102 is small in scale. Alternatively, the numbers for the different types of participants can be larger (e.g., five, ten, fifteen, fifty) if the collaboration session 102 is large in scale.

The system 100 is “integrated” in the sense that it seamlessly provides common collaboration session features so that the human participant(s) 104(1-N), the robotic device participant(s) 106(1-N), and the AI agent participant(s) 108(1-N) can all work together toward a mission 110 to be completed within a geographical environment 112. That is, the collaboration session 102 may be executed in relation to the mission 110 and the geographical environment 112. The mission 110 may be related to a response to an event and a set of tasks to be completed in accordance with the mission 110 is distributed across different human and/or robotic device roles with varied responsibilities. Consequently, the robotic device participants 106(1-N) reflect robotic devices that are operating and physically located in the geographical environment 112. A robotic device participant 106 is a programmable device configured to implement a series of physical actions automatically. In this context, “automatically” means the physical actions are implemented via the embedded programming of the robotic device participant 106 and/or via remote control of the robotic device participant 106 (e.g., when a human and robotic device are not co-located).

As an illustrative example, an event may be a natural disaster such as a fire from a lightning strike, a hurricane, or an earthquake. The use of robotic devices 106(1-N) can be helpful in responding to a natural disaster event. Typically, multiple organizations respond to execute and/or complete a mission 110 with the goal of helping people that are affected by the natural disaster event. For instance, first tasks for the mission 110 may be related to finding and rescuing survivors (e.g., removing people from dangerous areas). Second tasks for the mission 110 may be related to limiting further damage caused by the natural disaster event (e.g., finding areas that are burning and extinguishing the fire, securing unstable buildings). Third tasks for the mission 110 may be related to identifying damaged/offline “utility” infrastructure (e.g., electric grid infrastructure, water supply infrastructure, gas pipeline infrastructure) and fixing the damage/offline utility infrastructure so it comes back online in due time.

In this illustrative example, the multiple organizations often include different government agencies from local, state, and/or federal jurisdictions. Moreover, the multiple organizations may include private and/or charitable organizations as well. Each of the organizations may include their own personnel (e.g., the human participants 104(1-N)), their own experiences and/or procedures with respect to deploying robotic devices 106(1-N) to the geographical environment 112 in which the event occurs, as well as their own execution and/or communications infrastructure to operate the robotic devices 106(1-N). When different personnel and different types of robotic devices 106(1-N) from different organizations converge on the geographical environment 112 in response to an event such as a natural disaster, it is difficult to coordinate the tasks so that the mission can be achieved in a more effective and efficient manner.

The collaboration session 102 creates an effective and efficient solution for human participants 104(1-N) and robotic device participants 106(1-N) to coordinate the performance of the mission 110 in the geographical environment 112. Additionally, the collaboration session 102 allows for the AI agent participants 108(1-N) to assist in the coordination of the performance of the mission 110 in the geographical environment 112. For instance, via the execution of the collaboration session 102, humans from different organizations that use heterogenous robotic devices (e.g., different types of robotic devices, different types of communications) can quickly connect through a central, integrated system 100 to collaborate and coordinate performance of tasks that are intended to complete the mission 110.

The illustrative example of a natural disaster event provided above is a larger-scale event. However, it is understood in the context of this disclosure that a mission 110 can be implemented at different scales. For instance, a mission 110 can also be implemented in response to a smaller-scale event that only requires coordination and collaboration between a limited number of humans (e.g., one, two, or three humans), a limited number of robotic devices (e.g., one, two, or three robotic devices), and a limited number of artificial intelligence agents (e.g., one, two, or three artificial intelligence agents). For example, a human participant 104 may create a collaboration session 102 to coordinate with a robotic device participant 106 and/or an AI agent participant 108 to find a particular team member (e.g., determine a current location of the particular team member) in an office building so the team member can resolve a project issue a team has encountered. In this example, the event is the project issue and the mission 110 is finding the particular team member in the office building, which represents the geographical environment 112. In another example discussed herein, a collaboration session 102 may be created for human participants 104(1-N) to coordinate with robotic device participants 106(1-N) and/or artificial intelligence agent participants 108(1-N) to execute tasks at a construction site.

Consequently, the coordination enabled via a collaboration session 102 described herein may be scaled to apply in any context in which work (e.g., a mission 110) needs to be done by a human, a robotic device, and an AI agent. Various contexts include disaster response, safety and security, healthcare and medical instrumentation, manufacturing and industrial lines/warehouses, office and/or personal management, agriculture, construction, and so forth. Accordingly, a geographical environment 112, as described herein, can include an identifiable “real-world” setting and/or area. The identifiable real-world setting and/or area can be indoor, such as an office building, a retail building, a personal residence, a warehouse, a hospital, a medical office, a factory floor, a manufacturing line, or other types of settings and/or areas within physical structures that can be blueprint- or human-defined. Alternatively, the identifiable real-world setting and/or area can be outdoor, such as a forest, a mountain, a construction site, a neighborhood, a town, a city, a county, a state, a country, a field, a pasture, or other type of outdoor settings and/or areas that can be map- or human-defined.

Robotic device participants 106(1-N) can operate on land, on water, in the air, in space, or a combination thereof, and can be programmed to perform different tasks. For example, an unmanned aerial vehicle (UAV) may be tasked with capturing video and/or dropping items from the sky. A sea drone may be tasked with capturing video and/or providing supplies to an area that cannot be reached by land. A bomb disposal robotic device may be tasked with capturing video and/or safely disabling an explosive device. A backhoe robotic device may be tasked with capturing video and/or moving dirt, rocks, and/or rubble. A dump truck robotic device may be tasked with capturing video and hauling away dirt, rocks, and/or rubble. An office or retail robotic device may be tasked with stocking retail and/or supply shelves. A warehouse robotic device may be tasked with sorting items in bins. A manufacturing robotic device may be tasked with connecting two parts of an apparatus. These example robotic devices are just a few of the numerous different types of robotic devices that have been manufactured and configured to perform various tasks in varying contexts.

A participant (e.g., a human participant 104, a robotic device participant 106, an AI agent participant 108) starts the collaboration session 102 by creating the collaboration session 102 and joining the collaboration session 102. In one example, the collaboration session 102 reflects a virtual meeting (e.g., videoconference) setting. The participant that starts the collaboration session 102 can then add other participants to the collaboration session 102 via an invitation to join. After the collaboration session 102 is started, the integrated system 100 generates an interaction environment 114 for the collaboration session 102. As shown in the examples described below, the interaction environment 114 includes a graphical representation 116 for each of the participants 104(1-N), 106(1-N), 108(1-N) that have joined the collaboration session 102. In this way, the human participants 104(1-N) can view and/or interact with various resources (e.g., robotic device participants 106(1-N), AI agent participants 108(1-N)) that are available and/or deployed to assist in completion of the mission 110.

As described in further detail below, the system 100 generates graphical representations 116 for the AI agent participants 108(1-N) based on different types 118 of the AI agent participants 118. The system 100 can determine a type 118 of the AI agent participants 108(1-N) by mapping identifiers (e.g., names) of the AI agent participants 108(1-N) to defined types 118 or by accessing metadata for the AI agent participants 108(1-N) which defines a type 118. A first example type of AI agent participant includes a general-purpose type 120 of AI agent participant. A general-purpose type 120 of AI agent participant is one that provides general intelligence to mission execution (e.g., general construction safety practices for a construction site, general understanding of how fires spread when responding to a forest fire). A second example type of AI agent participant includes a specific-purpose type 121 of AI agent participant. A specific-purpose type 121 of AI agent participant is one that is dedicated to providing support for a specific type of robotic device participant 106, and thus, provides specific intelligence to mission execution. Consequently, a specific-purpose type 121 of AI agent participant is configured and trained at a lower level to support tasks capable of being executed by a specific type of robotic device participant 106, while a general-purpose type 120 of AI agent participant is configured and trained at a higher level to support more general goals, strategies, policies, practices related to the mission 110.

The system 100 then provides the interaction environment 114 to a computing device 122A-B associated with a human participant 104. In one example, the interaction environment 114 is displayed on a computing screen in two-dimensions, and thus, the computing device 122A can be a desktop computer, a gaming device, a tablet computer, a personal data assistant (PDA), a laptop computer, a telecommunication device (e.g., a smartphone), a wearable device (e.g., a smartwatch), an automotive computer, a network-enabled television, or any other sort of computing device capable of displaying the interaction environment in two dimensions. In another example, the interaction environment 114 is displayed in an immersive environment that includes more than two dimensions (e.g., a 3D environment), and thus, the computing device 122B can be a virtual reality (VR) computing device, an augmented reality (AR) computing device, or a mixed reality (MR) computing device.

FIG. 1 further illustrates that the system 100 enables communications 123 between the collaboration session 102 and each of the participants 104(1-N), 106(1-N), 108(1-N) that have joined the collaboration session 102. In one example, the communications 123 allow for the robotic device participants 106(1-N) to transmit sensor data 124 and/or location data 126 to the collaboration session. The sensor data 124 can include one or more of image data (e.g., still images) captured by an image capture device embedded in or attached to the robotic device participant, video data (e.g., a sequence of video frames) captured by a video capture device embedded in or attached to the robotic device participant, audio data captured by a microphone embedded in or attached to the robotic device participant, temperature data captured by a thermometer embedded in or attached to the robotic device participant, air quality data captured by an air quality sensor embedded in or attached to the robotic device participant, pressure data captured by a pressure sensor embedded in or attached to the robotic device participant, velocity data captured by a velocity sensor embedded in or attached to the robotic device participant, smoke data captured by a smoke detecting sensor embedded in or attached to the robotic device participant, gas data captured by a gas detecting sensor embedded in or attached to the robotic device participant, thermal data captured by a thermal sensor embedded in or attached to the robotic device participant, depth data captured by a depth sensor embedded in or attached to the robotic device participant, odor (smell) data captured by an odor sensor embedded in or attached to the robotic device participant, lidar data captured by a laser component embedded in or attached to the robotic device participant, radar data captured by a radar component embedded in or attached to the robotic device participant, or infrared (IR) data captured by an IR sensor embedded in or attached to the robotic device participant. While a list of example types of data and/or sensors is provided above, it is understood in the context of this disclosure, that a robotic device participant 106 can be configured with hardware, firmware, and/or software to detect and/or sense any type of environmental data. The location data 126 can reflect a location, or position, of a robotic device participant 106 in the geographical environment 112 (e.g., a Global Positioning System (GPS) location).

In another example, the communications 123 allow for the human participants 104(1-N) to transmit and/or receive individual streams of data corresponding to the participants 104(1-N), 106(1-N), 108(1-N), such as audio and/or visual data that capture the appearance and speech of a participant in the collaboration session, a video stream, or video feed, from a camera embedded on a robotic device, and so forth.

In yet another example, the communications 123 allow for the AI agent participants 108(1-N) to receive a context of the interaction environment 114 in a consumable format (e.g., code-based format), as stored in a data structure 128 for the collaboration session 102. Access to the context of the whole interaction environment 114, or a particular aspect of the interaction environment 114 (e.g., a video stream from a robotic device participant 106) enables an AI agent participant 108 to understand and/or analyze particular characteristics of the collaboration session 102.

Consequently, regardless of the size and/or scope of the mission 110 and/or a scale of an event to which the mission 110 responds, the collaboration session 102 described herein enables the different types of participants 104(1-N), 106(1-N), 108(1-N) to work together to complete the mission 110. The collaboration session 102 presents a low barrier of entry for humans and/or robotic devices to be part of a coordinated mission 110. Moreover, the collaboration session 102 enables the integration of heterogenous robotic devices (e.g., different fleets of robotic devices) that are not designed and/or configured to communicate with one another. Moreover, through the use of the accessible AI agents, the collaboration session 102 enables effective participation for humans without detailed working knowledge of the robotic devices deployed to the geographical environment 112 in which the mission 110 is being implemented, thereby reducing the cognitive load required for successful missions and increasing the overall efficiency for mission completion.

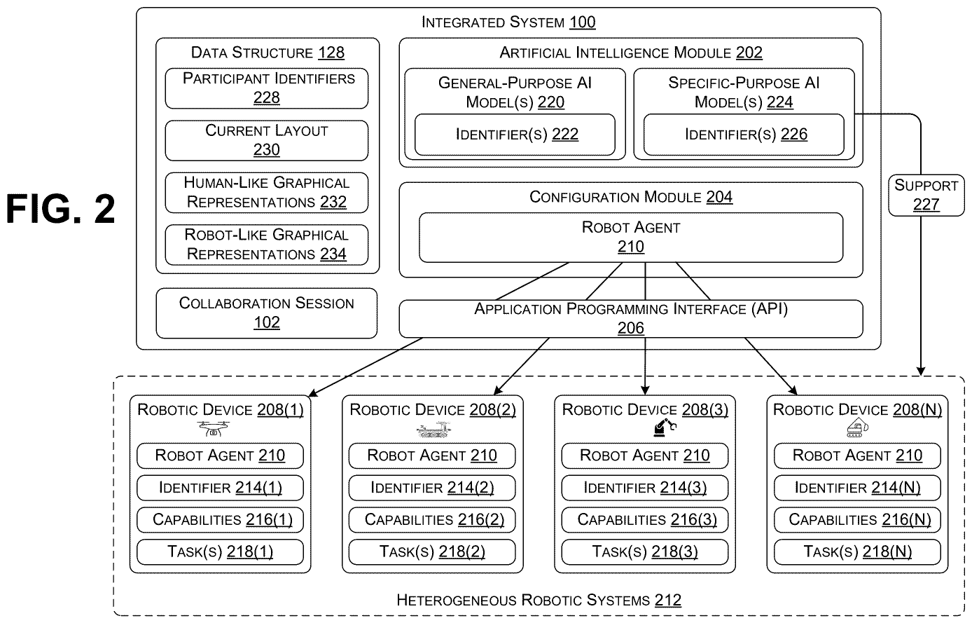

FIG. 2 illustrates further aspects of the integrated system 100 executing the collaboration session 102 that graphically represents AI agent participants 108(1-N) based on different types 118. The integrated system 100 includes an artificial intelligence (AI) module 202 and a configuration module 204. The functionality described herein in association with the illustrated modules can be performed by a fewer number of modules or a larger number of modules on one device (e.g., server) in the integrated system 100 or spread across multiple devices in the integrated system 100.

The configuration module 204 is configured to expose an application programming interface (API) 206 that allows different types of robotic devices 208(1-N) to access and download a robot agent 210 that enables robot device participation in the collaboration session 102. The robot agent 210 includes centralized code (e.g., a software development kit, application programming interface(s)) that configures the different types of robotic devices 208(1-N) with communication software that is compatible with the collaboration session 102. That is, after downloading and installing the robot agent 210, a robotic device 208 can join and participate in the collaboration session 102 via the communication (e.g., transmission) of robot data (e.g., sensor data 124 and/or location data 126).

Thus, the robot agent 210 made available by the configuration module 204 via the API 206 configures a bi-directional communication bridge between a robotic device 208 and the collaboration session 102. More specifically, this bi-directional communication bridge connects the robotic device 208 to cloud infrastructure that hosts the collaboration session 102 via different types of networks including private and/or public local area networks (LANs), private and/or public metropolitan area networks (MANs), private and/or public wide area networks (WANs), Wi-Fi networks, public and/or private mobile networks (e.g., 5G networks, LTE networks), satellite networks, radio networks, and so forth.

As illustrated in FIG. 2, the robotic devices 208(1-N) are heterogeneous 212 robotic devices. More specifically, the robotic devices 208(1-N) respectively include identifiers 214(1-N) that can either define, or be mapped to, different hardware, firmware, and/or software components. As shown, robotic device 208(1) has an identifier 214(1) associated with a first set of capabilities 216(1) with respect to hardware, firmware, and/or software components of an unmanned aerial vehicle (UAV) configured to perform particular task(s) 218(1). Robotic device 208(2) has an identifier 214(2) associated with a second set of capabilities 216(2) with respect to hardware, firmware, and/or software components of a track crawler robotic device configured to perform particular task(s) 218(2). Robotic device 208(3) has an identifier 214(3) associated with a third set of capabilities 216(3) with respect to hardware, firmware, and/or software components of an arm-based robotic device configured to perform particular task(s) 218(3) (e.g., pick up and move an object). Robotic device 208(N) has an identifier 214(N) associated with a Nth set of capabilities 216(N) with respect to hardware, firmware, and/or software components of a backhoe robotic device configured to perform particular task(s) 218(N). A version of the robot agent 210 downloaded and installed on the robotic devices 208(1-N) can be a common version. Alternatively, a version of the robot agent 210 downloaded and installed on the robotic devices 208(1-N) can be a customized version (e.g., the centralized code has been tailored based on an identifier 214).

In various examples, the invitation to join the collaboration session 102 is a notification that wakes a robotic device 208 from a sleep state and/or activates the robot agent 210 to enable the bi-directional communication bridge to/from the collaboration session 102. As described above, after a robotic device 208 has joined the collaboration session, the robotic device can start participating by communicating (e.g., reporting) sensor data 124 and/or location data 126 to the collaboration session 102.

The AI module 202 provides the collaboration session 102 access to an intelligence backbone in the form of AI models (e.g., multi-modal generative-AI models, large language models (LLMs), small language models (SLMs)). In various examples, the AI module 202 includes general-purpose AI models 220 and associated identifiers 222. A general-purpose AI model 220 can perform general intelligence support for the interaction environment 114, considering the mission 110. Furthermore, the general-purpose AI model 220 can serve as a conduit between humans and specific-purpose AI model(s) 224 with associated identifier(s) 226.

Each type of robotic device 208(1-N) may have a dedicated specific-purpose AI model 224 to assist with, or support 227, task(s) 218(1-N). Thus, after the robotic devices 208(1-N) join the communication session 102, the corresponding specific-purpose AI models 224 dedicated to the robotic devices 208(1-N) can be added or invited to the collaboration session 102. In various examples, AI processing can occur anywhere within a distributed, cloud environment. That is, the AI process can occur at a robotic device 208 (e.g., via a small language model implemented in the robot agent 210), at an edge location, or in the cloud.

In some instances, the general-purpose AI model(s) 220 and/or the specific-purpose AI model(s) 224 comprise large action models (LAMs) and/or small action models (SAMs) that work in combination with other pre-trained or customized models, such as LLMs, SLMs, large multimodal models, and/or small multimodal models. While language models have the main function of generating text, action models can generate and/or perform concrete actions with a given set of instructions or commands from a human participant. Consequently, the AI agent participants 108(1-N) can use action models to act like humans in terms of analyzing data and then acting based on the analysis. For example, while a language model (e.g., LLM, SLM) might be used to understand and respond to a chat message, an action model (e.g., a LAM, a SAM) could autonomously generate and perform tasks described by the chat message. Consequently, action models are sophisticated components that help an AI agent participant 108 understand and execute complex tasks.

In various examples, components of an action model include a foundational language model, as well as a reinforcement learning from human feedback (RLHF) component or a direct preference optimization (DPO) component to fine tune the foundational language model (e.g., make the foundational language model more accurately understand different areas or topics). The language model is then connected to an external tool (e.g., a robotic device participant) that perform actions on its own, which essentially turns the language model into an action model. Consequently, action models are configured to interact with various systems and/or interfaces to perform tasks that involve actual actions, such as controlling robotic device participants.

As further described in examples herein, if the system 100 determines that a type of AI agent participant is a general-purpose type 120 of artificial intelligence agent participant, then the graphical representation 116 generated for the AI agent participant is a human-like graphical representation in. If the system 100 determines that a type of AI agent participant is a specific-purpose type 121 of AI agent participant, then the graphical representation 116 generated for the artificial intelligence agent participant is a robot-like graphical representation.

Further shown in FIG. 2 is the data structure 128 for the collaboration session 102 and/or interaction environment 114. Again, the data structure 128 includes code reflecting the context of the collaboration session 102 and/or interaction environment 114. To this end, the data structure 128 includes participant identifiers 228, a current layout 230 of the interaction environment 114, human-like graphical representations 232 for general-purpose type 120 AI agent participants, and robot-like graphical representations 234 for specific-purpose type 121 AI agent participants, each of which is further discussed herein.

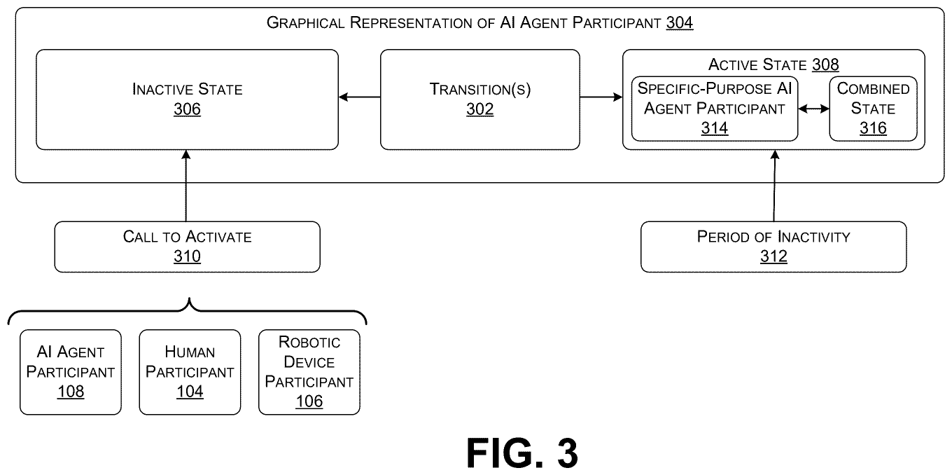

FIG. 3 illustrates state transitions 302 that occur with respect to a graphical representation of an AI agent participant 304 in a collaboration session 102. As mentioned above, the graphical representation 116 generated for an artificial intelligence agent participant 108 can have different states. A first example state includes an inactive state 306. The graphical representation generated for the AI agent participant 304 is displayed in the inactive state 306 when the AI agent participant is present in the collaboration session 102 but has not been called upon to use its intelligence to provide information. A second example state includes an active state 308. The graphical representation generated for the AI agent participant 304 is displayed in the active state 308 when the AI agent participant is called upon to use its intelligence to provide information in the context of the collaboration session 102.

It is noted that, in some instances, the disclosed states are related to visual activity that is graphically output to provide an element of visual cues and/or feedback for human consumption purposes. Accordingly, an AI agent participant that has not been called upon to use its intelligence to provide information (e.g., output information in the interaction environment 114) may still be consuming and analyzing data in the background in preparation, or anticipation, of being called upon to use its intelligence to provide information in the context of the collaboration session 102.

Again, the inactive state 306 and the active state 308 are graphically distinguished from one another to provide an element of visual cues and/or feedback to the human participants as to which artificial intelligence agent participants are actively engaged from a graphical perspective. For example, the active state 308 provides a larger and/or more detailed view of the human-like 232 and/or robot-like 234 graphical representations. In another example, the active state 308 provides animated elements to help personify the human-like 232 and/or robot-like 234 graphical representations (e.g., move lips to reflect speech, move arms and/or shoulders to perform a gesture, change facial expressions for emphasis). In a more specific example, the active state 308 of a specific-purpose type 121 of AI agent participant can audibly explain tasks that a robotic device participant 106 is implementing in the geographical environment 112.

Accordingly, the system 100 can determine that an AI agent participant, for which the graphical representation 116 is currently displayed in the inactive state 306, has been called upon to use it intelligence to provide information in the context of the collaboration session. This is illustrated in FIG. 3 as a call to activate 310, which can be a form of input that causes the AI agent participant (e.g., one of AI agent participants 108(1-N)) to perform an analysis associated with an aspect of the interaction environment 114, to output (e.g., display) a result of the analysis as artificial intelligence, and/or to generate and transmit an instruction to a robotic device participant 708 (e.g., one of robotic device participants 106(1-N)) that is deployed to a geographical environment 112 to assist with completion of a mission 110 as a result of the analysis. The call to activate 310 can be implemented by an(other) AI agent participant 108 (e.g., one AI agent participant can be configured to call on another AI agent participant), a human participant 104, or a robotic device participant 106 (e.g., a robotic device participant can all on the AI agent participant), as shown in FIG. 3.

The input that causes the call to activate 310 can be a text-based and/or voice input, e.g., in the form of a prompt (e.g., entered via text or spoken via a voice command). The prompt may be an instructional prompt that directs the AI agent participant to perform a specific task or an interpretive prompt that asks the AI agent participant to interpret or analyze information. Alternatively, the prompt may be a generative prompt that requests the AI agent participant to create new content such as text or images.

Based on the call to activate 310, the system transitions 302 the graphical representation for the AI agent participant 304 from the inactive state 306 to the active state 308. In various examples, the system 100 can determine that a period of inactivity 312 (e.g., thirty seconds, one minute, five minutes), associated with the AI agent participant while the graphical representation is currently displayed in the active state 308, has expired in the context of the collaboration session 102. Based on the expiration of the period of inactivity 312 while in the active state 308, the system 100 transitions 302 the graphical representation for the AI agent participant 304 from the active state 308 back to the inactive state 306.

After being called upon, the AI agent participant uses a corresponding AI model (e.g., a general purpose AI model 220 or a specific-purpose AI model 224) to act in accordance with the input. That is, the AI agent participant can perform an analysis of information associated with the collaboration session 102 and/or interaction environment 114 and display AI data associated with the analysis via the interaction environment 114. Alternatively, the AI agent participant can generate an instruction and transmit, via the collaboration session 102, the instruction to robotic device participant. In various examples, the instruction is generated and transmitted via a file that includes text and/or executable code in a format that is understood by the robotic device participant such that the robotic device participant can execute the task described in the input.

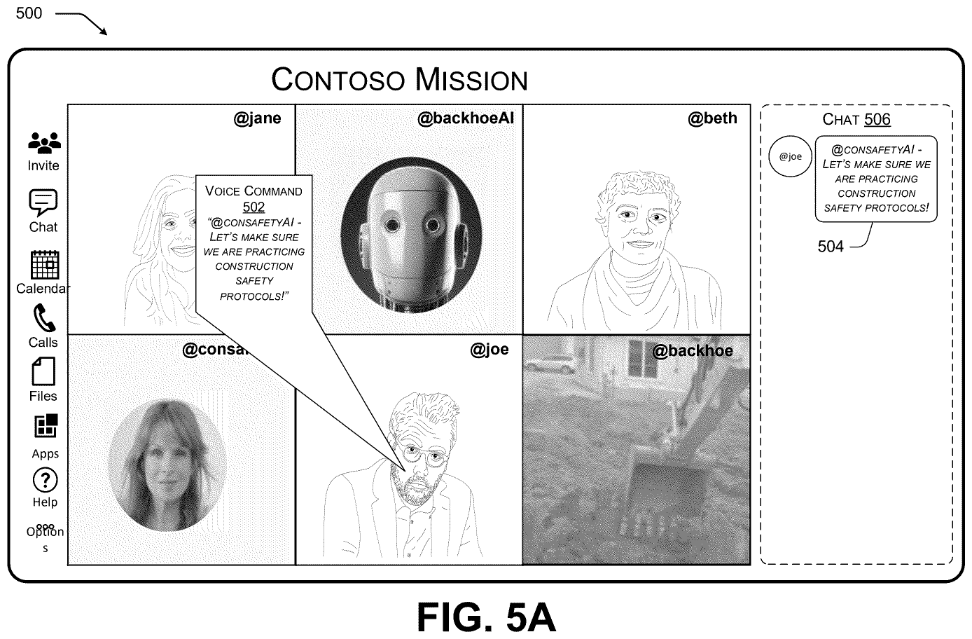

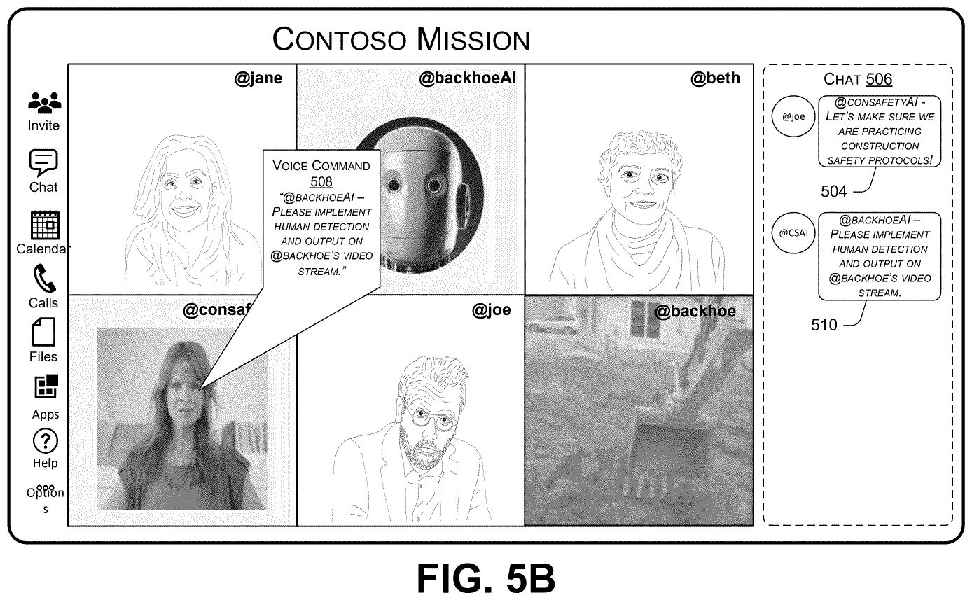

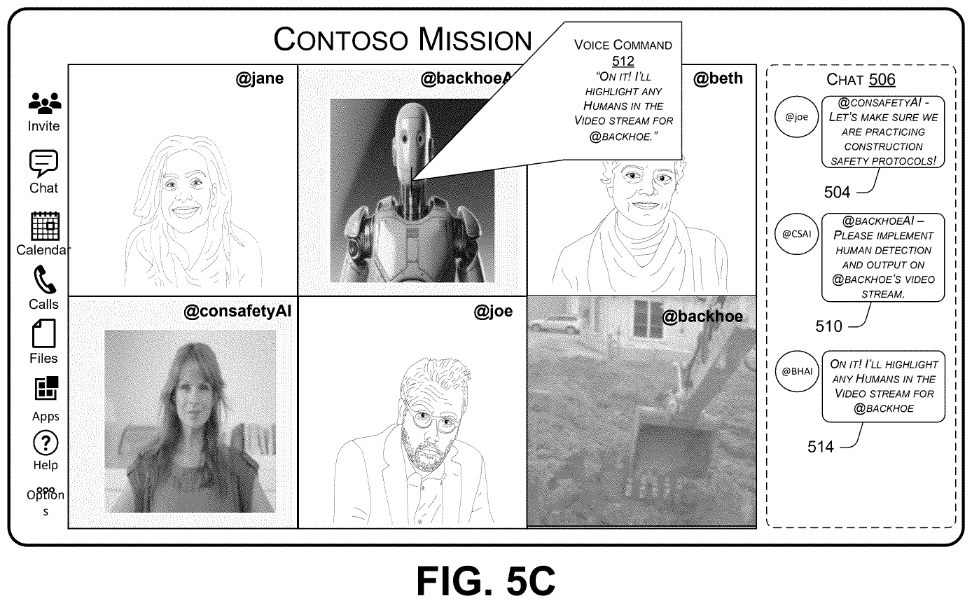

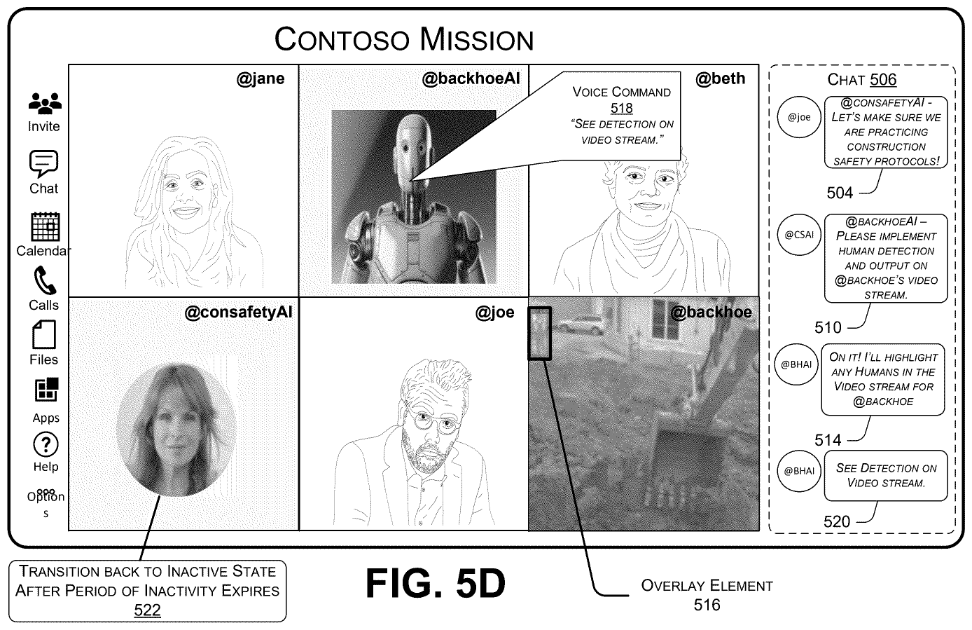

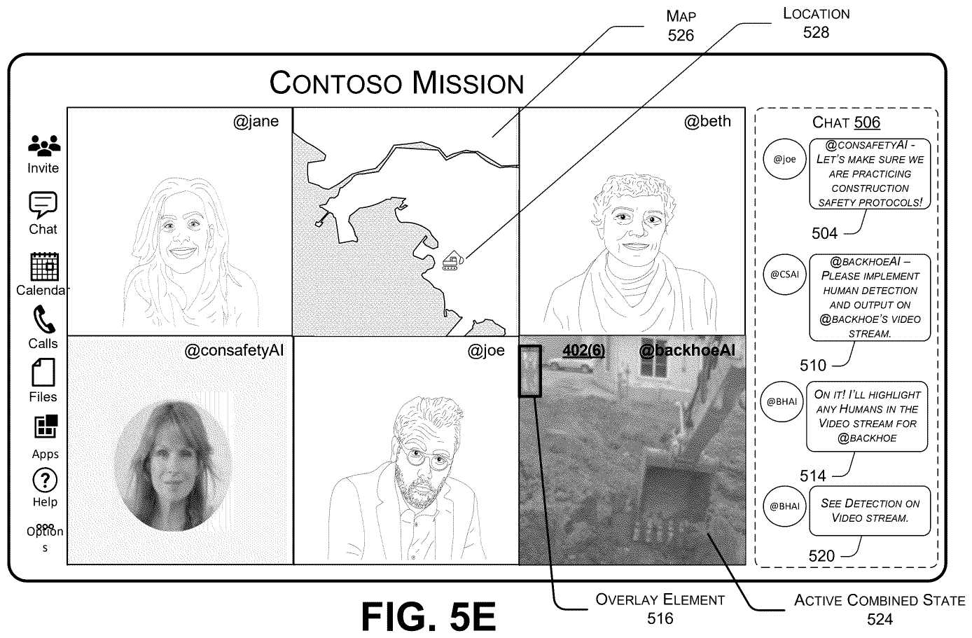

In various examples, the active state 308 of a specific-purpose AI agent participant 314 can also be in a combined state 316, where the graphical representation of the specific-purpose AI agent participant 314 and a graphical representation of a robotic device participant 106 which the specific-purpose AI agent participant 314 supports are combined into a single display area of the interaction environment. An example of this is shown in FIG. 5E below.

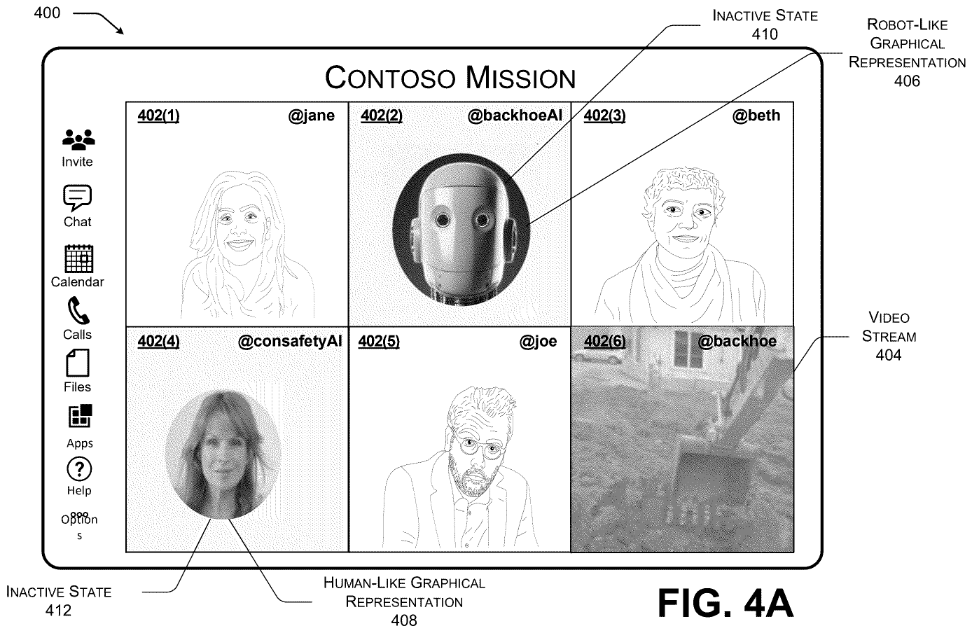

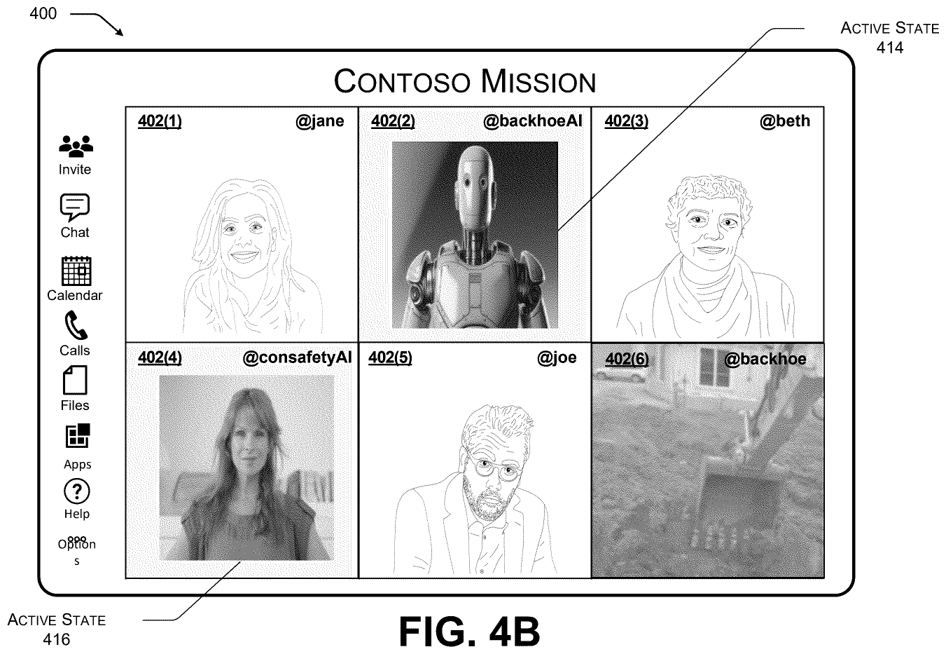

FIG. 4A illustrates an example interaction environment 400 where graphical representations for artificial intelligence agent participants based on type are displayed (e.g., via computing device 122A-B). As shown, the mission 110 is entitled the “Contoso Mission”, which is directed to the example context of working at a construction site. Accordingly, the interaction environment 400 includes display areas 402(1-6) that display graphical representations 116 for six participants. Additionally, the display areas 402(1-6) display identifiers for the six participants.

For example, display area 402(1) shows that a human participant 104 identified as “@jane” has joined the collaboration session 102 and the display area 402(1) includes a graphical representation 116 of “@jane”, e.g., in the form of a video stream being captured by a video camera on Jane's computing device 122A. Display area 402(2) shows that an AI agent participant 108 identified as “@backhoeAI” has joined the collaboration session 102 and the display area 402(2) includes a graphical representation 116 of “@backhoeAI”. Display area 402(3) shows that a human participant 104 identified as “@beth” has joined the collaboration session 102 and the display area 402(3) includes a graphical representation 116 of “@beth”, e.g., in the form of a video stream being captured by a video camera on Beth's computing device 122A. Display area 402(4) shows that an AI agent participant 108 identified as “@consafetyAI” has joined the collaboration session 102 and the display area 402(4) includes a graphical representation 116 of “@consafetyAI”. Display area 402(5) shows that a human participant 104 identified as “@joe” has joined the collaboration session 102 and the display area 402(5) includes a graphical representation 116 of “@joe”, e.g., in the form of a video stream being captured by a video camera on Joe's computing device 122A. Finally, area 402(6) shows that a robotic device participant 106 identified as “@backhoe” has joined the collaboration session 102 and the display area 402(6) includes a graphical representation 116 of “@backhoe”, e.g., in the form of a video stream 404 being captured by a video capture component embedded in or attached to “@backhoe”.

In this example, the AI agent participant 108 identified as “@backhoeAI” is a specific-purpose type 121 of AI agent participant that is dedicated to supporting backhoe-type robotic devices including the robotic device participant 106 identified as “@backhoe”. Accordingly, the graphical representation 116 of “@backhoeAI” is a robot-like graphical representation 406 that has robot-like features, as shown in FIG. 4A. In contrast, the AI agent participant 108 identified as “@consafetyAI” (e.g., “consafety” represents “construction safety”) is a general-purpose type 120 of AI agent participant that provides intelligence with respect to general construction safety practices, regardless of the types of robotic devices deployed in a geographical environment. Accordingly, the graphical representation 116 of “@consafetyAI” is a human-like graphical representation 408 that has human-like features (e.g., mouth, eyes, nose, ears, hair, neck), as shown in FIG. 4A

As further highlighted in FIG. 4A, the graphical representation 116 of “@backhoeAI” is displayed in the inactive state 410 as “@backhoeAI” has not currently or recently been called upon to use its intelligence to provide (e.g., output) information in the context of the collaboration session 102. Similarly, the graphical representation 116 of “@consafetyAI” is displayed in the inactive state 412 as “@consafetyAI” has not currently or recently been called upon to use its intelligence to provide (e.g., output) information in the context of the collaboration session 102.

FIG. 4B illustrates the example interaction environment of FIG. 4A, where the graphical representations of the AI agent participants “@backhoeAI” and “@consafetyAI” have transitioned from inactive states to active states. As further described below with respect to the example of FIGS. 5A-5D, the AI agent participants “@backhoeAI” and “@consafetyAI” have been called upon to use their intelligence to provide (e.g., output) information in the context of the collaboration session. Accordingly, FIG. 4B illustrates that the graphical representation of AI agent participant “@backhoeAI” has transitioned to the active state 414, which increases the size of a view window for the robot-like graphical representation 406 (compared to the inactive state 410) and provides animated elements to help personify the robot-like graphical representation 406 (e.g., move arms and/or shoulders to perform a gesture, turn its head). Similarly, FIG. 4B illustrates that the graphical representation of AI agent participant “@consafetyAI” has transitioned to the active state 416, which increases the size of a view window for the human-like graphical representation 408 (compared to the inactive state 412) and provides animated elements to help personify the human-like graphical representation 408 (e.g., move lips to reflect speech, move arms and/or shoulders to perform a gesture, change facial expressions for emphasis).

FIGS. 4A-B include a smaller number of graphical representations for a smaller number of respective participants in a collaboration session 102. However, it is understood in the context of this disclosure that a collaboration session 102 can have a larger number of participants (e.g., twenty participants, thirty participants, fifty participants) depending on the size and/or scope of the mission 110. Consequently, via the interaction environment 114 (e.g., interaction environment 400) provided by a collaboration session 102, human participants 104(1-N) are provided with a centralized space that allows the human participants 104(1-N) to not only view helpful resources (e.g., robotic device participants 106(1-N), AI agent participants 108(1-N)) that are available and/or deployed to assist in completion of the mission 110, but also interact with the helpful resources in a way that provides effective and efficient coordination.

FIG. 5A illustrates an example interaction environment 500 where an artificial intelligence agent participant is called upon by a human participant to use its intelligence and to provide information. As shown, the human participant “@joe” provides input that serves as a call to activate 310. More specifically, in one example, the human participant “@joe” speaks a voice command 502—“@consafety AI—Let's make sure we are practicing construction safety protocols!” during the collaboration session 102. In an alternative example, the human participant “@joe” posts a message 504 in a chat 506 associated with the collaboration session 102, the message 504 stating “@consafetyAI—Let's make sure we are practicing construction safety protocols!”

In response to the voice command 502 or message 504 from the human participant “@joe”, FIG. 5B illustrates how the graphical representation of AI agent participant “@consafetyAI” has transitioned from the inactive state 412 (as shown in FIG. 5A) to the active state 416. In the active state 416, the AI agent participant “@consafetyAI” performs its analysis on the collaboration session 102 and interaction environment 114 to identify a construction safety protocol to implement. In one example, the AI agent participant “@consafetyAI” responds to the human participant “@joe” by speaking its own voice command 508—“@backhoeAI—Please implement human detection and output on @backhoe's video stream.” In an alternative example, the AI agent participant “@consafetyAI” posts its own message 510 in the chat 506, which states “@backhoeAI—Please implement human detection and output on @backhoe's video stream.”

In response to the voice command 508 or message 510 from the AI agent participant “@consafetyAI”, FIG. 5C illustrates how the graphical representation of AI agent participant “@backhoeAI” has transitioned from the inactive state 410 (as shown in FIG. 5A) to the active state 414. In the active state 414, the AI agent participant “@backhoeAI” performs its analysis on the collaboration session 102 and interaction environment 114 to implement human detection to prevent the possibility of a construction site accident. In one example, the AI agent participant “@backhoeAI” responds to the AI agent participant “@consafetyAI” by speaking its own voice command 512—“On it! I'll highlight any humans in the video stream for @backhoe.” In an alternative example, the AI agent participant “@backhoeAI” posts its own message 514 in the chat 506, which states “On it! I'll highlight any humans in the video stream for @backhoe.”

FIG. 5D illustrates an example interaction environment of FIG. 5C, where an artificial intelligence agent participant is able to output (e.g., as an overlay) graphical elements based on its analysis. More specifically, the AI agent participant “@backhoeAI” is configured to analyze a video stream from the robotic device participant “@backhoe” (e.g., in display area 402(6)) and generate an output based on the analysis in a context of the video stream. In the example of FIGS. 5C and 5D the analysis relates to human detection. Accordingly, the video stream in display area 402(6) includes an overlay element 516 that frames a detected human at the construction site in which the robotic device participant “@backhoe” is executing tasks. Additionally or alternatively, the AI agent participant “@backhoeAI” can speak another voice command 518—“See detection on video stream” to notify other participants of a human at the construction site in which the robotic device participant “@backhoe” is executing tasks. Or, the AI agent participant “@backhoeAI” posts another message 520 in the chat 506, which states “See detection on video stream”, to notify other participants of a human at the construction site in which the robotic device participant “@backhoe” is executing tasks.

FIG. 5D further illustrates how the graphical representation for the AI agent participant “@consafetyAI” has transitioned from the active state 416 back to the inactive state 412 after a period of inactivity (e.g., thirty seconds, one minute, five minutes) has expired 522.

FIG. 5E illustrates the example interaction environment of FIG. 5C, where the AI agent participant “@backhoeAI” and the robotic device participant “@backhoe” are combined into a single display area 402(6) of the interaction environment. Consequently, the AI agent participant “@backhoeAI” is in the active combined state 524 (e.g., the combined state 316 as described above with respect to FIG. 3). As shown, the identifier shown in display area has switched from “@backhoe” (in FIG. 5C) to “@backhoeAI” and the robot-like graphical representation for the AI agent participant “@backhoeAI” is no longer displayed. In the example of FIG. 5E, the robot-like graphical representation for the AI agent participant “@backhoeAI” is replaced with a map 526 of the geographical environment 112 that displays, via an icon, a location 528 of the robotic device participant “@backhoe”.

The combined state 316 merges graphical elements from AI agent and robotic device participants. For instance, the active combined state 524 shown in FIG. 5E includes the video stream from the robotic device participant “@backhoe” and the overlay element 516 from AI agent participant “@backhoeAI”. In this example, a human participant (e.g., “@jane”, “@beth”, “@joe”) viewing the interaction environment can deduce that the AI agent participant “@backhoeAI” and the robotic device participant “@backhoe” are combined into a single display area 402(6) via the matching “backhoe” in their identifiers.

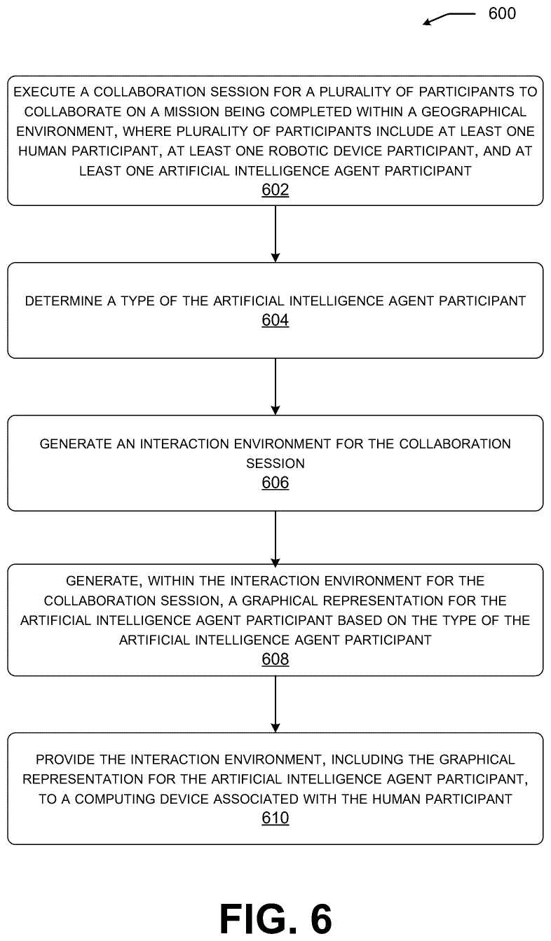

FIG. 6 illustrates a process 600 for executing a collaboration session between at least one human participant, at least one robotic device participant, and at least one artificial intelligence agent participant, where the system graphically represents the at least one artificial intelligence agent participant based on different types. The process 600 begins at operation 602 where a system executes a collaboration session for a plurality of participants to collaborate on a mission being completed within a geographical environment. As described above, the plurality of participants includes the artificial intelligence agent participant, a human participant, and a robotic device participant.

At operation 604, the system determines a type of the artificial intelligence agent participant. In various examples, the types of artificial intelligence agent participants includes a general-purpose type and a specific-purpose type.

At operation 606, the system generates an interaction environment for the collaboration session.

At operation 608, the system generates, within the interaction environment for the collaboration session, a graphical representation for the artificial intelligence agent participant based on the type of the artificial intelligence agent participant. As described above, the graphical representation may be a human-like graphical representation or a robot-like graphical representation.

At operation 610, the system provides the interaction environment, including the graphical representation for the artificial intelligence agent participant, to a computing device associated with the human participant.

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the processes or an alternate processes. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated processes can end at any time and need not be performed in their entirety. Some or all operations of the processes, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the processes can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

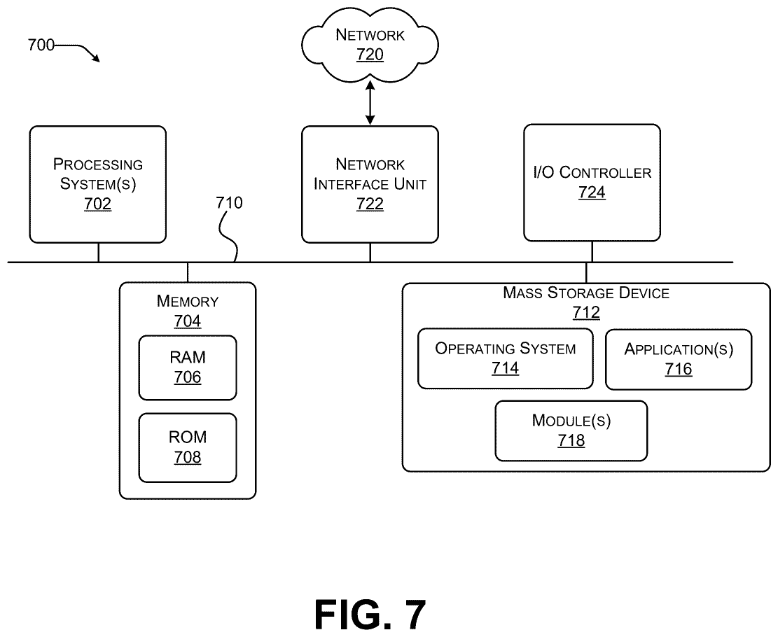

FIG. 7 shows additional details of an example computer architecture 700 for a device, such as a computer (e.g., computing device 122) or a server configured as part of the integrated system 100, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The disclosure presented herein also encompasses the subject matter set forth in the following clauses.

Example Clause A, a method that generates a graphical representation of an artificial intelligence agent participant in a context of a collaboration session, the method comprising: executing the collaboration session for a plurality of participants to collaborate on a mission being completed within a geographical environment, wherein the plurality of participants includes the artificial intelligence agent participant, a human participant, and a robotic device participant; determining a type of the artificial intelligence agent participant; generating an interaction environment for the collaboration session; generating, within the interaction environment for the collaboration session, a graphical representation for the artificial intelligence agent participant based on the type of the artificial intelligence agent participant; and providing the interaction environment, including the graphical representation for the artificial intelligence agent participant, to a computing device associated with the human participant.

Example Clause B, the method of Example Clause A, wherein: the type of the artificial intelligence agent participant comprises a general-purpose type; and the graphical representation for the artificial intelligence agent comprises a human-like graphical representation.

Example Clause C, the method of Example Clause A, wherein: the type of the artificial intelligence agent participant comprises a specific-purpose type based on a type of the robotic device participant; and the graphical representation for the artificial intelligence agent comprises a robot-like graphical representation associated with the type of the robotic device participant.

Example Clause D, the method of any one of Example Clauses A through C, wherein: the graphical representation for the artificial intelligence agent participant comprises an inactive state of the artificial intelligence agent participant; and the method further comprises: determining that the artificial intelligence agent participant has been called upon to provide information in the context of the collaboration session; and in response to determining that the artificial intelligence agent participant has been called upon to provide the information in the context of the collaboration session, transitioning the graphical representation for the artificial intelligence agent participant from the inactive state of the artificial intelligence agent participant to an active state of the artificial intelligence agent participant.

Example Clause E, the method of Example Clause D, wherein the active state of the artificial intelligence agent participant comprises an active combined state in which first graphical elements associated with the artificial intelligence agent participant are merged with second graphical elements associated with a corresponding robotic device participant that is supported by the artificial intelligence agent participant.

Example Clause F, the method of Example Clause D, further comprising: determining that a period of inactivity associated with the artificial intelligence agent participant has expired in the context of the collaboration session; and in response to determining that the period of inactivity associated with the artificial intelligence agent participant has expired in the context of the collaboration session, transitioning the graphical representation for the artificial intelligence agent participant from the active state of the artificial intelligence agent participant back to the inactive state of the artificial intelligence agent participant.

Example Clause G, the method of Example Clause D, wherein the active state of the artificial intelligence agent participant explains tasks that the robotic device participant is implementing in the geographical environment.

Example Clause H, the method of any one of Example Clauses A through G, wherein: the artificial intelligence agent participant is configured to analyze a video stream associated with the robotic device participant and generate an output based on the analysis in a context of the video stream; and the interaction environment displays the video stream and the output.

Example Clause I, a system for generating a graphical representation of an artificial intelligence agent participant in a context of a collaboration session comprising: a processing system; and a computer readable storage medium storing instructions that, when executed by the processing system, cause the system to perform operations comprising: executing the collaboration session for a plurality of participants to collaborate on a mission being completed within a geographical environment, wherein the plurality of participants includes the artificial intelligence agent participant, a human participant, and a robotic device participant; determining a type of the artificial intelligence agent participant; generating an interaction environment for the collaboration session; generating, within the interaction environment for the collaboration session, a graphical representation for the artificial intelligence agent participant based on the type of the artificial intelligence agent participant; and providing the interaction environment, including the graphical representation for the artificial intelligence agent participant, to a computing device associated with the human participant.

Example Clause J, the system of Example Clause I, wherein: the type of the artificial intelligence agent participant comprises a general-purpose type; and the graphical representation for the artificial intelligence agent comprises a human-like graphical representation.

Example Clause K, the system of Example Clause I, wherein: the type of the artificial intelligence agent participant comprises a specific-purpose type based on a type of the robotic device participant; and the graphical representation for the artificial intelligence agent comprises a robot-like graphical representation associated with the type of the robotic device participant.

Example Clause L, the system of any one of Example Clauses I through K, wherein: the graphical representation for the artificial intelligence agent participant comprises an inactive state of the artificial intelligence agent participant; and the operations further comprise: determining that the artificial intelligence agent participant has been called upon to provide information in the context of the collaboration session; and in response to determining that the artificial intelligence agent participant has been called upon to provide the information in the context of the collaboration session, transitioning the graphical representation for the artificial intelligence agent participant from the inactive state of the artificial intelligence agent participant to an active state of the artificial intelligence agent participant.

Example Clause M, the system of Example Clause L, wherein the active state of the artificial intelligence agent participant comprises an active combined state in which first graphical elements associated with the artificial intelligence agent participant are merged with second graphical elements associated with a corresponding robotic device participant that is supported by the artificial intelligence agent participant.

Example Clause N, the system of Example Clause L, wherein the operations further comprise: determining that a period of inactivity associated with the artificial intelligence agent participant has expired in the context of the collaboration session; and in response to determining that the period of inactivity associated with the artificial intelligence agent participant has expired in the context of the collaboration session, transitioning the graphical representation for the artificial intelligence agent participant from the active state of the artificial intelligence agent participant back to the inactive state of the artificial intelligence agent participant.

Example Clause O, the system of Example Clause L, wherein the active state of the artificial intelligence agent participant explains tasks that the robotic device participant is implementing in the geographical environment.

Example Clause P, the system of any one of Example Clauses I through O, wherein: the artificial intelligence agent participant is configured to analyze a video stream associated with the robotic device participant and generate an output based on the analysis in a context of the video stream; and the interaction environment displays the video stream and the output.

Example Clause Q, a computer readable storage medium storing instructions that, when executed by a processing system, cause a system to perform operations comprising: executing a collaboration session for a plurality of participants to collaborate on a mission being completed within a geographical environment, wherein the plurality of participants includes an artificial intelligence agent participant, a human participant, and a robotic device participant; determining a type of the artificial intelligence agent participant; generating an interaction environment for the collaboration session; generating, within the interaction environment for the collaboration session, a graphical representation for the artificial intelligence agent participant based on the type of the artificial intelligence agent participant; and providing the interaction environment, including the graphical representation for the artificial intelligence agent participant, to a computing device associated with the human participant.

Example Clause R, the computer readable storage medium of Example Clause Q, wherein: the type of the artificial intelligence agent participant comprises a general-purpose type; and the graphical representation for the artificial intelligence agent comprises a human-like graphical representation.

Example Clause S, the computer readable storage medium of Example Clause Q, wherein: the type of the artificial intelligence agent participant comprises a specific-purpose type based on a type of the robotic device participant; and the graphical representation for the artificial intelligence agent comprises a robot-like graphical representation associated with the type of the robotic device participant.

Example Clause T, the computer readable storage medium of any one of Example Clauses Q through S, wherein: the graphical representation for the artificial intelligence agent participant comprises an inactive state of the artificial intelligence agent participant; and the operations further comprise: determining that the artificial intelligence agent participant has been called upon to provide information in the context of the collaboration session; and in response to determining that the artificial intelligence agent participant has been called upon to provide the information in the context of the collaboration session, transitioning the graphical representation for the artificial intelligence agent participant from the inactive state of the artificial intelligence agent participant to an active state of the artificial intelligence agent participant.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the scope of the inventions disclosed herein. The accompanying claims and their equivalents are intended to cover such forms or modifications as would fall within the scope of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method that generates a graphical representation of an artificial intelligence agent participant in a context of a collaboration session, the method comprising:
executing the collaboration session for a plurality of participants to collaborate on a mission being completed within a geographical environment, wherein the plurality of participants includes the artificial intelligence agent participant, a human participant, and a robotic device participant;
determining a type of the artificial intelligence agent participant;
generating an interaction environment for the collaboration session;
generating, within the interaction environment for the collaboration session, a graphical representation for the artificial intelligence agent participant based on the type of the artificial intelligence agent participant; and
providing the interaction environment, including the graphical representation for the artificial intelligence agent participant, to a computing device associated with the human participant.

2. The method of claim 1, wherein:
the type of the artificial intelligence agent participant comprises a general-purpose type; and
the graphical representation for the artificial intelligence agent comprises a human-like graphical representation.

3. The method of claim 1, wherein:
the type of the artificial intelligence agent participant comprises a specific-purpose type based on a type of the robotic device participant; and
the graphical representation for the artificial intelligence agent comprises a robot-like graphical representation associated with the type of the robotic device participant.

4. The method of claim 1, wherein:
the graphical representation for the artificial intelligence agent participant comprises an inactive state of the artificial intelligence agent participant; and
the method further comprises:
determining that the artificial intelligence agent participant has been called upon to provide information in the context of the collaboration session; and
in response to determining that the artificial intelligence agent participant has been called upon to provide the information in the context of the collaboration session, transitioning the graphical representation for the artificial intelligence agent participant from the inactive state of the artificial intelligence agent participant to an active state of the artificial intelligence agent participant.

5. The method of claim 4, wherein the active state of the artificial intelligence agent participant comprises an active combined state in which first graphical elements associated with the artificial intelligence agent participant are merged with second graphical elements associated with a corresponding robotic device participant that is supported by the artificial intelligence agent participant.

6. The method of claim 4, further comprising:
determining that a period of inactivity associated with the artificial intelligence agent participant has expired in the context of the collaboration session; and
in response to determining that the period of inactivity associated with the artificial intelligence agent participant has expired in the context of the collaboration session, transitioning the graphical representation for the artificial intelligence agent participant from the active state of the artificial intelligence agent participant back to the inactive state of the artificial intelligence agent participant.

7. The method of claim 4, wherein the active state of the artificial intelligence agent participant explains tasks that the robotic device participant is implementing in the geographical environment.

8. The method of claim 1, wherein:
the artificial intelligence agent participant is configured to analyze a video stream associated with the robotic device participant and generate an output based on the analysis in a context of the video stream; and
the interaction environment displays the video stream and the output.

9. A system for generating a graphical representation of an artificial intelligence agent participant in a context of a collaboration session comprising:
a processing system; and
a computer readable storage medium storing instructions that, when executed by the processing system, cause the system to perform operations comprising:
executing the collaboration session for a plurality of participants to collaborate on a mission being completed within a geographical environment, wherein the plurality of participants includes the artificial intelligence agent participant, a human participant, and a robotic device participant;
determining a type of the artificial intelligence agent participant;
generating an interaction environment for the collaboration session;
generating, within the interaction environment for the collaboration session, a graphical representation for the artificial intelligence agent participant based on the type of the artificial intelligence agent participant; and
providing the interaction environment, including the graphical representation for the artificial intelligence agent participant, to a computing device associated with the human participant.

10. The system of claim 9, wherein:
the type of the artificial intelligence agent participant comprises a general-purpose type; and
the graphical representation for the artificial intelligence agent comprises a human-like graphical representation.

11. The system of claim 9, wherein:
the type of the artificial intelligence agent participant comprises a specific-purpose type based on a type of the robotic device participant; and
the graphical representation for the artificial intelligence agent comprises a robot-like graphical representation associated with the type of the robotic device participant.

12. The system of claim 8, wherein:
the graphical representation for the artificial intelligence agent participant comprises an inactive state of the artificial intelligence agent participant; and
the operations further comprise:
determining that the artificial intelligence agent participant has been called upon to provide information in the context of the collaboration session; and
in response to determining that the artificial intelligence agent participant has been called upon to provide the information in the context of the collaboration session, transitioning the graphical representation for the artificial intelligence agent participant from the inactive state of the artificial intelligence agent participant to an active state of the artificial intelligence agent participant.

13. The system of claim 12, wherein the active state of the artificial intelligence agent participant comprises an active combined state in which first graphical elements associated with the artificial intelligence agent participant are merged with second graphical elements associated with a corresponding robotic device participant that is supported by the artificial intelligence agent participant.

14. The system of claim 12, wherein the operations further comprise:
determining that a period of inactivity associated with the artificial intelligence agent participant has expired in the context of the collaboration session; and
in response to determining that the period of inactivity associated with the artificial intelligence agent participant has expired in the context of the collaboration session, transitioning the graphical representation for the artificial intelligence agent participant from the active state of the artificial intelligence agent participant back to the inactive state of the artificial intelligence agent participant.

15. The system of claim 12, wherein the active state of the artificial intelligence agent participant explains tasks that the robotic device participant is implementing in the geographical environment.

16. The system of claim 9, wherein:
the artificial intelligence agent participant is configured to analyze a video stream associated with the robotic device participant and generate an output based on the analysis in a context of the video stream; and
the interaction environment displays the video stream and the output.

17. A computer readable storage medium storing instructions that, when executed by a processing system, cause a system to perform operations comprising:
executing a collaboration session for a plurality of participants to collaborate on a mission being completed within a geographical environment, wherein the plurality of participants includes an artificial intelligence agent participant, a human participant, and a robotic device participant;
determining a type of the artificial intelligence agent participant;
generating an interaction environment for the collaboration session;
generating, within the interaction environment for the collaboration session, a graphical representation for the artificial intelligence agent participant based on the type of the artificial intelligence agent participant; and
providing the interaction environment, including the graphical representation for the artificial intelligence agent participant, to a computing device associated with the human participant.

18. The computer readable storage medium of claim 17, wherein:
the type of the artificial intelligence agent participant comprises a general-purpose type; and
the graphical representation for the artificial intelligence agent comprises a human-like graphical representation.

19. The computer readable storage medium of claim 17, wherein:
the type of the artificial intelligence agent participant comprises a specific-purpose type based on a type of the robotic device participant; and
the graphical representation for the artificial intelligence agent comprises a robot-like graphical representation associated with the type of the robotic device participant.

20. The computer readable storage medium of claim 17, wherein:
the graphical representation for the artificial intelligence agent participant comprises an inactive state of the artificial intelligence agent participant; and
the operations further comprise:
determining that the artificial intelligence agent participant has been called upon to provide information in the context of the collaboration session; and
in response to determining that the artificial intelligence agent participant has been called upon to provide the information in the context of the collaboration session, transitioning the graphical representation for the artificial intelligence agent participant from the inactive state of the artificial intelligence agent participant to an active state of the artificial intelligence agent participant.
